(19) United States
(12) Patent Application Publication
(10) Pub. No.: US 2025/0215133 A1
(43) Pub. Date: Jul. 3, 2025

(54) RESIN COMPOSITION, CURED PRODUCT, MULTILAYER BODY, TRANSPARENT ANTENNA AND IMAGE DISPLAY DEVICE

(71) Applicant: Resonac Corporation, Tokyo (JP)

(72) Inventors: Daisuke OTSUKI, Tokyo (JP); Takeshi NOJIRI, Tokyo (JP); Ryoh TAKAHASHI, Tokyo (JP); Yutaro TAKAMATSU, Tokyo (JP)

(21) Appl. No.: 18/850,300

(22) PCT Filed: Mar. 29, 2023
(86) PCT No.: PCT/JP2023/012882

§ 371 Date: Sep. 24, 2024

(30) Foreign Application Priority Data
Mar. 31, 2022 (JP) 2022-059928
Aug. 10, 2022 (JP) 2022-127911
Aug. 10, 2022 (JP) 2022-127939

(51) Int. Cl. C08F 287/00; C08F 4/36; C08J 7/04; C08J 7/044

(52) U.S. Cl. CPC C08F 287/00; C08F 4/36; C08J 7/0423; C08J 7/044

(57) ABSTRACT

A resin composition containing: a styrene-based block copolymer; a (meth)acrylic compound; and a polymerization initiator. A laminate having: a base material film; and a transparent resin layer disposed on the base material film, in which the transparent resin layer contains at least one selected from the group consisting of the resin composition and a cured product thereof. A transparent antenna 110 having: a transparent base material 110a; a conductive member 110b disposed on the transparent base material 110a; and a covering member 110c disposed on the conductive member 110b, in which at least one selected from the group consisting of the transparent base material 110a and the covering member 110c contains a cured product of the resin composition. An image display device 100 having the transparent antenna 110.

### TECHNICAL FIELD

The present disclosure relates to a resin composition, a cured product, a laminate, a transparent antenna, an image display device, and the like.

### BACKGROUND ART

Antennas for receiving radio waves are installed in image display devices (for example, image display devices in various electronic devices such as personal computers, navigation systems, mobile phones, watches, and electronic dictionaries), constituent members of automobiles, buildings, and the like. For example, there is a case where an image display device with a built-in antenna is used, and in recent years, in order to coping with a reduction in size and thickness, diversification in shape, and the like of the image display device and ensure the likelihood of design, it has been proposed to place a transparent and low-visibility antenna (hereinafter, also referred to as a “transparent antenna”) on an image display unit for displaying an image. Various members have been studied on members for obtaining a transparent antenna (see, for example, Patent Literature 1 below).

### CITATION LIST

### Patent Literature

Patent Literature 1: Japanese Unexamined Patent Publication No. 2011-091788

### SUMMARY OF INVENTION

### Technical Problem

As a constituent member of a transparent antenna, there is a case where a cured product of a resin composition is used. From the viewpoint of maintaining sufficient durability, such a cured product is required to have a high mechanical strength, and is required to have, for example, a high tensile elastic modulus.

An object of one aspect of the present disclosure is to provide a resin composition capable of obtaining a cured product having a high tensile elastic modulus. An object of another aspect of the present disclosure is to provide a cured product of this resin composition. An object of another aspect of the present disclosure is to provide a laminate using this resin composition or a cured product thereof. An object of another aspect of the present disclosure is to provide a transparent antenna using a cured product of this resin composition. An object of another aspect of the present disclosure is to provide an image display device using this transparent antenna.

### Solution to Problem

The present disclosure relates to the following [1] to [19] and the like in several aspects.

[1]A resin composition containing: a styrene-based block copolymer; a (meth)acrylic compound; and a polymerization initiator.
[2] The resin composition described in [1], in which the styrene-based block copolymer includes a styrene-butadiene-styrene block copolymer.
[3] The resin composition described in [1] or [2], in which a content of the styrene-based block copolymer is 50% by mass or more based on a total mass of the resin composition.
[4] The resin composition described in any one of [1] to [3], in which the (meth)acrylic compound includes a methacrylic compound.
[5] The resin composition described in any one of [1] to [4], in which the (meth)acrylic compound includes alkanediol di(meth)acrylate.
[6] The resin composition described in any one of [1] to [5], in which the (meth)acrylic compound includes alkanediol dimethacrylate.
[7] The resin composition described in any one of [1] to [6], in which the (meth)acrylic compound includes a compound represented by General Formula (I) below:

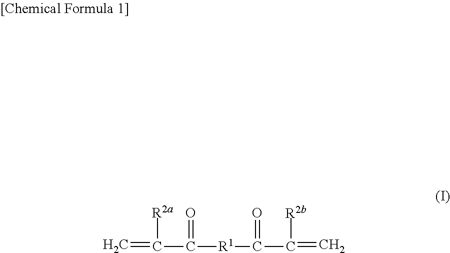

[in the formula, R¹ represents a group having 9 or less carbon atoms and 2 or more oxygen atoms, and R^{2a} and R^{2b} each independently represent a hydrogen atom or a methyl group.]
[8] The resin composition described in [7], in which the (meth)acrylic compound includes a compound in which at least one of R^{2a} and R^{2b} is a methyl group in General Formula (I) above.
[9] The resin composition described in any one of [1] to [8], in which a content of the (meth)acrylic compound is 1 to 300 parts by mass with respect to 100 parts by mass of the styrene-based block copolymer.
[10] The resin composition described in any one of [1] to [9], in which the polymerization initiator includes a peroxide.
[11] The resin composition described in any one of [1] to [10], in which the polymerization initiator includes a peroxyester.
[12]A cured product of the resin composition described in any one of [1] to [11].
[13]A laminate having: a base material film; and a transparent resin layer disposed on the base material film, in which the transparent resin layer contains at least one selected from the group consisting of the resin composition described in any one of [1] to [11] and a cured product thereof.
[14] The laminate described in [13], further having a conductive member disposed on the transparent resin layer.
[15] The laminate described in [14], in which the conductive member contains copper.
[16] The laminate described in [14] or [15], in which a thickness of the conductive member is 5 μm or less.
[17]A transparent antenna having: a transparent base material; a conductive member disposed on the transparent base material; and a covering member disposed on the conductive member, in which at least one selected from the group consisting of the transparent base material and the covering member contains a cured product of the resin composition described in any one of [1] to [11].
[18] The transparent antenna described in [17], in which the conductive member has a mesh-shaped portion.
[19] The transparent antenna described in [17] or [18], in which the conductive member contains copper.
[20] An image display device having the transparent antenna described in any one of [17] to [19].

### Advantageous Effects of Invention

According to one aspect of the present disclosure, it is possible to provide a resin composition capable of obtaining a cured product having a high tensile elastic modulus. According to another aspect of the present disclosure, it is possible to provide a cured product of this resin composition. According to another aspect of the present disclosure, it is possible to provide a laminate using this resin composition or a cured product thereof. According to another aspect of the present disclosure, it is possible to provide a transparent antenna using a cured product of this resin composition. According to another aspect of the present disclosure, it is possible to provide an image display device using this transparent antenna.

### BRIEF DESCRIPTION OF DRAWINGS

FIG. 1 is a schematic sectional view illustrating an example of a laminate.

FIG. 2 is a schematic sectional view illustrating an example of the laminate.

FIG. 3 is a schematic sectional view illustrating an example of an image display device.

FIG. 4 is a schematic sectional view illustrating an example of the image display device.

### DESCRIPTION OF EMBODIMENTS

Hereinafter, an embodiment of the present disclosure will be described in detail. However, the present disclosure is not limited to the following embodiment.

In the present specification, a numerical range that has been indicated by use of “to” indicates the range that includes the numerical values which are described before and after “to”, as the minimum value and the maximum value, respectively. “A or more” in a numerical range indicates A and a range of more than A. “A or less” in a numerical range indicates A and a range of less than A. In numerical ranges described in stages in the present specification, the upper limit value or the lower limit value of a numerical range in a certain stage may be arbitrarily combined with the upper limit value or the lower limit value of a numerical range in the other stage. In the numerical range described in the present specification, the upper limit value or the lower limit value of the numerical range may be replaced with values described in Examples. “A or B” may include either A or B, and may include both. Materials exemplified in the present specification can be used alone, and two or more types thereof can be used in combination, unless otherwise specified. In the present specification, in a case where there are a plurality of substances corresponding to each component in a composition, unless otherwise specified, the content of each component in the composition indicates the total amount of the plurality of substances in the composition. The term “layer” includes not only a structure in which a layer is formed on the entire surface but also a structure in which a layer is formed on a part of the surface when observed as a plan view. The term “step” includes not only an independent step but also a step that is not explicitly distinguishable from other steps insofar as a desired function of the step is attained. “(Meth)acrylate” means at least one of acrylate and methacrylate corresponding thereto. The same applies to other analogous expressions such as “(meth)acryl”. The content of a (meth)acrylic compound indicates the total amount of an acrylic compound and a methacrylic compound. A hydroxy group does not include an OH group contained in a carboxy group.

A resin composition of the present embodiment contains a styrene-based block copolymer, a (meth)acrylic compound, and a polymerization initiator. The resin composition of the present embodiment can be used as a resin composition for a transparent antenna. The resin composition of the present embodiment may be used as a thermosetting resin composition, and may be used as a photocurable resin composition. A cured product of the present embodiment is obtained by curing the resin composition of the present embodiment, and is a cured product of the resin composition of the present embodiment. The cured product of the present embodiment may be in a semi-cured state, and may be in a completely cured state.

According to the resin composition of the present embodiment, a cured product having a high tensile elastic modulus can be obtained. According to the resin composition of the present embodiment, in the evaluation method described in Examples below, for example, the tensile elastic modulus of 50 Pa or more (preferably, 100 Pa or more, 150 Pa or more, 200 Pa or more, or the like) can be obtained. It is presumed that a cured product having a high tensile elastic modulus is obtained by an intermolecular interaction of block chains composed of a monomer unit derived from a styrene compound. However, the reason why a high tensile elastic modulus is obtained is not limited to this content.

According to one aspect of the resin composition of the present embodiment, a cured product having a high tensile elastic modulus and excellent transparency can be obtained.

A transparent antenna can be used in high-frequency-band communication for attaining high-speed and high-capacity communication. In the high-frequency-band communication, there is a tendency that a transmission loss is large. Therefore, as a constituent member of the transparent antenna, a cured product of the resin composition is required to have excellent dielectric properties.

According to one aspect of the resin composition of the present embodiment, a cured product having an excellent dielectric constant (a low dielectric constant) can be obtained. According to one aspect of the resin composition of the present embodiment, in the evaluation method described in Examples below, for example, a dielectric constant of 3.0 or less (preferably, 2.8 or less, 2.6 or less, 2.5 or less, or the like) can be obtained. Furthermore, according to one aspect of the resin composition of the present embodiment, a cured product having an excellent dielectric dissipation factor (a low dielectric dissipation factor) can be obtained.

According to one aspect of the resin composition of the present embodiment, in the evaluation method described in Examples below, for example, a dielectric dissipation factor of 0.0060 or less (preferably, 0.0050 or less, 0.0045 or less, 0.0040 or less, 0.0035 or less, 0.0030 or less, or the like) can be obtained.

The resin composition of the present embodiment contains the styrene-based block copolymer. The styrene-based block copolymer is a block copolymer having a styrene compound as a monomer unit (a block copolymer having a monomer unit derived from a styrene compound). The styrene-based block copolymer may be a block copolymer having a monomer unit of one styrene compound and a monomer unit of other styrene compound, and may be a block copolymer having a monomer unit of a styrene compound and a monomer unit of a compound not corresponding to the styrene compound. The styrene-based block copolymer may be an elastomer.

Examples of the styrene compound include styrene; alkyl styrenes such as methylstyrene, dimethylstyrene, trimethylstyrene, ethylstyrene, diethylstyrene, triethylstyrene, propylstyrene, butylstyrene, hexylstyrene, heptylstyrene, and octylstyrene; halogenated styrenes such as florostyrene, chlorostyrene, bromostyrene, dibromostyrene, and iodestyrene; nitrostyrene; acetylstyrene; and methoxystyrene. The styrene-based block copolymer may have styrene as a monomer unit from the viewpoint of easily obtaining a high tensile elastic modulus in the cured product and the viewpoint of easily obtaining excellent dielectric properties (a low dielectric constant, dielectric dissipation factor, or the like) in the cured product.

Examples of the styrene-based block copolymer include a styrene-butadiene-styrene block copolymer, a styrene-butylene-butadiene-styrene block copolymer, a styrene-isoprene-styrene block copolymer, a styrene-ethylene-butylene-styrene block copolymer, a styrene-ethylene-propylene-styrene block copolymer, and hydrogenated copolymers thereof. The styrene-based block copolymer may include a styrene-butadiene-styrene block copolymer from the viewpoint of easily obtaining a high tensile elastic modulus in the cured product. It is presumed that a high tensile elastic modulus is easily obtained in the cured product by an intermolecular interaction of block chains composed of a monomer unit derived from butadiene. However, the reason why a high tensile elastic modulus is easily obtained is not limited to this content. Furthermore, by using a styrene-butadiene-styrene block copolymer, it is easy to suppress wrinkles from occurring on a conductive member when the resin composition of the present embodiment is cured in a state where this resin composition is in contact with the conductive member (for example, a copper member).

The styrene-based block copolymer may be modified with a carboxylic anhydride, and may not be modified with a carboxylic anhydride. Examples of the carboxylic anhydride include dicarboxylic anhydrides such as maleic anhydride, phthalic anhydride, and itaconic anhydride. The styrene-based block copolymer may include a styrene-based block copolymer modified with a carboxylic anhydride, may include a styrene-based block copolymer modified with maleic anhydride, may include a styrene-butadiene-styrene block copolymer modified with a carboxylic anhydride, and may include a styrene-butadiene-styrene block copolymer modified with maleic anhydride, from the viewpoint of easily obtaining a cured product having high adhesiveness with respect to the conductive member. The styrene-based block copolymer may include a styrene-based block copolymer not modified with a carboxylic anhydride, may include a styrene-based block copolymer not modified with maleic anhydride, may include a styrene-butadiene-styrene block copolymer not modified with a carboxylic anhydride, and may include a styrene-butadiene-styrene block copolymer not modified with maleic anhydride, from the viewpoint of easily obtaining a high tensile elastic modulus in the cured product.

The content of the monomer unit of the styrene compound or the content of the monomer unit of styrene may be in the following range based on the total mass of the styrene-based block copolymer from the viewpoint of easily obtaining a high tensile elastic modulus in the cured product and the viewpoint of easily obtaining excellent dielectric properties (a low dielectric constant, dielectric dissipation factor, or the like) in the cured product. The content of the monomer unit may be 5% by mass or more, 10% by mass or more, 15% by mass or more, 20% by mass or more, 25% by mass or more, 30% by mass or more, 35% by mass or more, or 40% by mass or more. The content of the monomer unit may be 80% by mass or less, 75% by mass or less, 70% by mass or less, 65% by mass or less, 60% by mass or less, 55% by mass or less, 50% by mass or less, 45% by mass or less, or 40% by mass or less. From these viewpoints, the content of the monomer unit may be 5 to 80% by mass, 5 to 60% by mass, 5 to 50% by mass, 20 to 80% by mass, 20 to 60% by mass, 20 to 50% by mass, 30 to 80% by mass, 30 to 60% by mass, or 30 to 50% by mass.

The content of the styrene-based block copolymer may be 50% by mass or more, more than 50% by mass, 70% by mass or more, 90% by mass or more, 95% by mass or more, or 99% by mass or more, based on the total mass of a polymer (the total amount of a polymer contained in the resin composition), from the viewpoint of easily obtaining a high tensile elastic modulus in the cured product and the viewpoint of easily obtaining excellent dielectric properties (a low dielectric constant, dielectric dissipation factor, or the like) in the cured product. A polymer contained in the resin composition may be an embodiment substantially composed of the styrene-based block copolymer (an embodiment in which the content of the styrene-based block copolymer is substantially 100% by mass based on the total mass of a polymer contained in the resin composition).

MFR (melt flow rate; 200° C., 5 kgf (49 N); unit: g/10 min) of the styrene-based block copolymer as measured according to ISO 1133 may be in the following range. The MFR of the styrene-based block copolymer may be 1 or more, 2 or more, 3 or more, 4 or more, 5 or more, or 6 or more from the viewpoint of easily obtaining excellent dielectric properties (a low dielectric constant, dielectric dissipation factor, or the like) in the cured product. The MFR of the styrene-based block copolymer may be 7 or more. The MFR of the styrene-based block copolymer may be 10 or less, 9 or less, 8 or less, 7 or less, or 6 or less, from the viewpoint of easily obtaining a high tensile elastic modulus in the cured product. The MFR of the styrene-based block copolymer may be 5 or less. From these viewpoints, the MFR of the styrene-based block copolymer may be 1 to 10, 3 to 8, 5 to 7, 4 to 6, or 6 to 8.

The vicat softening temperature (test load: 10 N, temperature increase rate: 50° C./h) of the styrene-based block copolymer as measured according to ISO 306 may be in the following range. The vicat softening temperature of the styrene-based block copolymer may be 50° C. or higher, 60° C. or higher, 70° C. or higher, 72° C. or higher, 75° C. or higher, 80° C. or higher, 81° C. or higher, or 83° C. or higher. The vicat softening temperature of the styrene-based block copolymer may be 100° C. or lower, 90° C. or lower, 85° C. or lower, 83° C. or lower, 81° C. or lower, 80° C. or lower, 75° C. or lower, or 72° C. or lower, from the viewpoint of easily obtaining excellent dielectric properties (a low dielectric constant, dielectric dissipation factor, or the like) in the cured product. From these viewpoints, the vicat softening temperature of the styrene-based block copolymer may be 50 to 100° C., 60 to 90° C., or 70 to 85° C.

As the content of a polymer (a polymer contained in the resin composition) or the content of the styrene-based block copolymer, a content A may be in the following range based on the total mass of the resin composition (excluding the mass of an organic solvent), the total amount of a polymer (a polymer contained in the resin composition), the (meth)acrylic compound, and the polymerization initiator, the total amount of a polymer (a polymer contained in the resin composition), the methacrylic compound, and the polymerization initiator, the total amount of the styrene-based block copolymer, the (meth)acrylic compound, and the polymerization initiator, the total amount of the styrene-based block copolymer, the methacrylic compound, and the polymerization initiator, the total amount of a polymer (a polymer contained in the resin composition) and the (meth)acrylic compound, the total amount of a polymer (a polymer contained in the resin composition) and the methacrylic compound, the total amount of the styrene-based block copolymer and the (meth)acrylic compound, or the total amount of the styrene-based block copolymer and the methacrylic compound, from the viewpoint of easily obtaining a high tensile elastic modulus in the cured product and the viewpoint of easily obtaining excellent dielectric properties (a low dielectric constant, dielectric dissipation factor, or the like) in the cured product. The content A may be 20% by mass or more, more than 20% by mass, 30% by mass or more, more than 30% by mass, 40% by mass or more, more than 40% by mass, 50% by mass or more, more than 50% by mass, 60% by mass or more, 65% by mass or more, 70% by mass or more, 75% by mass or more, 78% by mass or more, or 80% by mass or more. The content A may be 99% by mass or less, 95% by mass or less, 90% by mass or less, 85% by mass or less, 82% by mass or less, or 80% by mass or less. From these viewpoints, the content A may be 20 to 99% by mass, 20 to 90% by mass, 20 to 85% by mass, 50 to 99% by mass, 50 to 90% by mass, 50 to 85% by mass, 70 to 99% by mass, 70 to 90% by mass, or 70 to 85% by mass.

The resin composition of the present embodiment contains the (meth)acrylic compound. The (meth)acrylic compound is a compound having a (meth)acryloyl group. The (meth)acrylic compound may not have an epoxy group, and may have an epoxy group.

The (meth)acrylic compound may include at least one selected from the group consisting of a monofunctional (meth)acrylic compound and a polyfunctional (meth)acrylic compound (a difunctional (meth)acrylic compound or a trifunctional or higher (meth)acrylic compound). For example, the “difunctional (meth)acrylic compound” means a compound in which the total number of an acryloyl group and a methacryloyl group in one molecule is 2. The (meth)acrylic compound may include a difunctional (meth)acrylic compound from the viewpoint of easily obtaining a high tensile elastic modulus in the cured product and the viewpoint of easily obtaining excellent dielectric properties (a low dielectric constant, dielectric dissipation factor, or the like) in the cured product.

Examples of the monofunctional (meth)acrylic compound include aliphatic (meth)acrylates such as methyl (meth)acrylate, ethyl (meth)acrylate, butyl (meth)acrylate, isobutyl (meth)acrylate, tert-butyl (meth)acrylate, butoxyethyl (meth)acrylate, isoamyl (meth)acrylate, hexyl (meth)acrylate, 2-ethylhexyl (meth)acrylate, heptyl (meth)acrylate, octylheptyl (meth)acrylate, nonyl (meth)acrylate, decyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, stearyl (meth)acrylate, behenyl (meth)acrylate, 2-hydroxyethyl (meth)acrylate, 2-hydroxypropyl (meth)acrylate, 3-chloro-2-hydroxypropyl (meth)acrylate, 2-hydroxybutyl (meth)acrylate, methoxypolyethylene glycol (meth)acrylate, ethoxypolyethylene glycol (meth)acrylate, methoxypolypropylene glycol (meth)acrylate, ethoxypolypropylene glycol (meth)acrylate, and mono(2-(meth)acryloyloxyethyl)succinate; alicyclic (meth)acrylates such as cyclopentyl (meth)acrylate, cyclohexyl (meth)acrylate, cyclopentyl (meth)acrylate, dicyclopentanyl (meth)acrylate, dicyclopentenyl (meth)acrylate, isobornyl (meth)acrylate, mono(2-(meth)acryloyloxyethyl)tetrahydrophthalate, and mono(2-(meth)acryloyloxyethyl)hexahydrophthalate; aromatic (meth)acrylates such as benzyl (meth)acrylate, phenyl (meth)acrylate, o-biphenyl (meth)acrylate, 1-naphthyl (meth)acrylate, 2-naphthyl (meth)acrylate, phenoxyethyl (meth)acrylate, p-cumylphenoxyethyl (meth)acrylate, o-phenylphenoxyethyl (meth)acrylate, 1-naphthoxyethyl (meth)acrylate, 2-naphthoxyethyl (meth)acrylate, phenoxypolyethylene glycol (meth)acrylate, nonylphenoxypolyethylene glycol (meth)acrylate, phenoxypolypropylene glycol (meth)acrylate, 2-hydroxy-3-phenoxypropyl (meth)acrylate, 2-hydroxy-3-(o-phenylphenoxy)propyl (meth)acrylate, 2-hydroxy-3-(1-naphthoxy)propyl (meth)acrylate, and 2-hydroxy-3-(2-naphthoxy)propyl (meth)acrylate; heterocyclic (meth)acrylates such as 2-tetrahydrofurfuryl (meth)acrylate, N-(meth)acryloyloxyethyl hexahydrophthalimide, and 2-(meth)acryloyloxyethyl-N-carbazole; (meth)acryloyl group-containing phosphates (for example, (meth)acryloyloxyethyl acid phosphate); and modified caprolactone thereof.

Examples of the difunctional (meth)acrylic compound include aliphatic (meth)acrylates (for example, alkanediol di(meth)acrylate) such as ethylene glycol di(meth)acrylate, diethylene glycol di(meth)acrylate, triethylene glycol di(meth)acrylate, tetraethylene glycol di(meth)acrylate, polyethylene glycol di(meth)acrylate, propylene glycol di(meth)acrylate, dipropylene glycol di(meth)acrylate, tripropylene glycol di(meth)acrylate, tetrapropylene glycol di(meth)acrylate, polypropylene glycol di(meth)acrylate, ethoxylated polypropylene glycol di(meth)acrylate, 1,3-butanediol di(meth)acrylate, 1,4-butanediol di(meth)acrylate, neopentyl glycol di(meth)acrylate, 3-methyl-1,5-pentanediol di(meth)acrylate, 1,6-hexanediol di(meth)acrylate, 2-butyl-2-ethyl-1,3-propanediol di(meth)acrylate, nonanediol di(meth)acrylate (for example, 1,9-nonanediol di(meth)acrylate), decanediol di(meth)acrylate (for example, 1,10-decanediol di(meth)acrylate), dodecanediol di(meth)acrylate (for example, 1,12-dodecanediol di(meth)acrylate), glycerin di(meth)acrylate, and ethoxylated 2-methyl-1,3-propanediol di(meth)acrylate; alicyclic (meth)acrylates such as cyclohexane dimethanol di(meth)acrylate, ethoxylated cyclohexane dimethanol di(meth)acrylate, propoxylated cyclohexane dimethanol di(meth)acrylate, ethoxylated propoxylated cyclohexane dimethanol di(meth)acrylate, tricyclodecane dimethanol di(meth)acrylate, ethoxylated tricyclodecane dimethanol di(meth)acrylate, propoxylated tricyclodecane dimethanol di(meth)acrylate, ethoxylated propoxylated tricyclodecane dimethanol di(meth)acrylate, ethoxylated hydrogenated bisphenol A di(meth)acrylate, propoxylated hydrogenated bisphenol A di(meth)acrylate, ethoxylated propoxylated hydrogenated bisphenol A di(meth)acrylate, ethoxylated hydrogenated bisphenol F di(meth)acrylate, propoxylated hydrogenated bisphenol F di(meth)acrylate, and ethoxylated propoxylated hydrogenated bisphenol F di(meth)acrylate; aromatic (meth)acrylates such as ethoxylated bisphenol A di(meth)acrylate, propoxylated bisphenol A di(meth)acrylate, ethoxylated propoxylated bisphenol A di(meth)acrylate, ethoxylated bisphenol F di(meth)acrylate, propoxylated bisphenol F di(meth)acrylate, ethoxylated propoxylated bisphenol F di(meth)acrylate, ethoxylated bisphenol AF di(meth)acrylate, propoxylated bisphenol AF di(meth)acrylate, ethoxylated propoxylated bisphenol AF di(meth)acrylate, ethoxylated fluorene-type di(meth)acrylate, propoxylated fluorene-type di(meth)acrylate, and ethoxylated propoxylated fluorene-type di(meth)acrylate; heterocyclic (meth)acrylates such as dioxane glycol di(meth)acrylate, ethoxylated isocyanuric acid di(meth)acrylate, propoxylated isocyanuric acid di(meth)acrylate, and ethoxylated propoxylated isocyanuric acid di(meth)acrylate; modified caprolactone thereof; aliphatic epoxy (meth)acrylate such as neopentyl glycol-type epoxy (meth)acrylate; alicyclic epoxy (meth)acrylate such as cyclohexane dimethanol-type epoxy (meth)acrylate, hydrogenated bisphenol A-type epoxy (meth)acrylate, and hydrogenated bisphenol F-type epoxy (meth)acrylate; and aromatic epoxy (meth)acrylates such as resorcinol-type epoxy (meth)acrylate, bisphenol A-type epoxy (meth)acrylate, bisphenol F-type epoxy (meth)acrylate, bisphenol AF-type epoxy (meth)acrylate, and fluorene-type epoxy (meth)acrylate.

Examples of the trifunctional or higher (meth)acrylic compound include aliphatic (meth)acrylates such as trimethylol propane tri(meth)acrylate, ethoxylated trimethylol propane tri(meth)acrylate, propoxylated trimethylol propane tri(meth)acrylate, ethoxylated propoxylated trimethylol propane tri(meth)acrylate, pentaerythritol tri(meth)acrylate, ethoxylated pentaerythritol tri(meth)acrylate, propoxylated pentaerythritol tri(meth)acrylate, ethoxylated propoxylated pentaerythritol tri(meth)acrylate, pentaerythritol tetra(meth)acrylate, ethoxylated pentaerythritol tetra(meth)acrylate, propoxylated pentaerythritol tetra(meth)acrylate, ethoxylated propoxylated pentaerythritol tetra(meth)acrylate, ditrimethylol propane tetra(meth)acrylate, dipentaerythritol hexa(meth)acrylate, ethoxylated dipentaerythritol hexa(meth)acrylate, and propoxylated dipentaerythritol hexa(meth)acrylate; heterocyclic (meth)acrylates such as ethoxylated isocyanuric acid tri(meth)acrylate, propoxylated isocyanuric acid tri(meth)acrylate, and ethoxylated propoxylated isocyanuric acid tri(meth)acrylate; modified caprolactone thereof; and aromatic epoxy (meth)acrylates such as phenol novolac-type epoxy (meth)acrylate and cresol novolac-type epoxy (meth)acrylate.

The (meth)acrylic compound may include an aliphatic (meth)acrylate from the viewpoint of easily obtaining a high tensile elastic modulus in the cured product and the viewpoint of easily obtaining excellent dielectric properties (a low dielectric constant, dielectric dissipation factor, or the like) in the cured product. The (meth)acrylic compound may include alkanediol di(meth)acrylate, may include alkanediol dimethacrylate, may include at least one selected from the group consisting of nonanediol di(meth)acrylate and dodecanediol di(meth)acrylate, and may include at least one selected from the group consisting of nonanediol dimethacrylate and dodecanediol dimethacrylate, from the viewpoint of easily obtaining a high tensile elastic modulus in the cured product and the viewpoint of easily obtaining excellent dielectric properties (a low dielectric constant, dielectric dissipation factor, or the like) in the cured product. The (meth)acrylic compound may include an acrylic compound (a compound having an acryloyl group). The (meth)acrylic compound may include a methacrylic compound (a compound having a methacryloyl group) from the viewpoint of easily obtaining a low dielectric dissipation factor in the cured product. It is presumed that, since the methacrylic compound has a methyl group in a methacryloyl group, a cured product having a low dielectric dissipation factor is obtained by suppression of molecular vibration due to polarization, an increase in hydrophobicity of the molecule, and the like. However, the reason why a low dielectric dissipation factor is obtained is not limited to this content. The methacrylic compound may not have an acryloyl group, and may have an acryloyl group.

The (meth)acrylic compound may include a compound represented by General Formula (I) below from the viewpoint of easily adjusting dielectric properties (a dielectric constant, a dielectric dissipation factor, or the like) in the cured product.

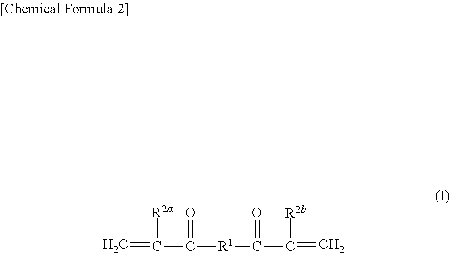

[In the formula, R¹ represents a group having 9 or less carbon atoms and 2 or more oxygen atoms, and R^{2a} and R^{2b} each independently represent a hydrogen atom or a methyl group.]

The number of carbon atoms of R¹ is 1 to 9. The number of carbon atoms of R¹ may be 2 or more, 3 or more, 4 or more, 5 or more, 6 or more, 7 or more, or 8 or more, from the viewpoint of easily obtaining excellent dielectric properties (a low dielectric constant, dielectric dissipation factor, or the like) in the cured product. The number of oxygen atoms of R¹ may be 6 or less, 5 or less, 4 or less, 3 or less, or 2 or less, from the viewpoint of easily obtaining excellent dielectric properties (a low dielectric constant, dielectric dissipation factor, or the like) in the cured product. R¹ may be a hydrocarbon group in which oxygen atoms are bonded to both ends, and may be a “—O—CₙH₂ₙ—O—” group (n=1 to 9). The (meth)acrylic compound may include a compound in which R¹ does not have a cyclic structure in General Formula (I), and may include a compound in which R¹ does not have an alicyclic ring in General Formula (I), from the viewpoint of easily obtaining excellent dielectric properties (a low dielectric constant, dielectric dissipation factor, or the like) in the cured product. The (meth)acrylic compound may include a compound in which at least one of R^{2a} and R^{2b} is a hydrogen atom in General Formula (I). The (meth)acrylic compound may include a compound in which at least one of R^{2a} and R^{2b} is a methyl group in General Formula (I), from the viewpoint of easily obtaining a low dielectric dissipation factor in the cured product.

The content of the compound represented by General Formula (I) may be 50% by mass or more, more than 50% by mass, 70% by mass or more, 90% by mass or more, 95% by mass or more, 99% by mass or more, or more than 99% by mass, based on the total mass of the (meth)acrylic compound or the total mass of the methacrylic compound, from the viewpoint of easily obtaining excellent dielectric properties (a low dielectric constant, dielectric dissipation factor, or the like) in the cured product. The (meth)acrylic compound contained in the resin composition may be an embodiment substantially composed of the compound represented by General Formula (I) (an embodiment in which the content of the compound represented by General Formula (I) is substantially 100% by mass based on the total mass of the (meth)acrylic compound contained in the resin composition). The methacrylic compound contained in the resin composition may be an embodiment substantially composed of the compound represented by General Formula (I) (an embodiment in which the content of the compound represented by General Formula (I) is substantially 100% by mass based on the total mass of the methacrylic compound contained in the resin composition).

The (meth)acrylic compound may include a (meth)acrylic compound having a hydroxy group, and may not include a (meth)acrylic compound having a hydroxy group. The methacrylic compound may include a methacrylic compound having a hydroxy group, and may not include a methacrylic compound having a hydroxy group. The content of the (meth)acrylic compound having a hydroxy group or the content of the methacrylic compound having a hydroxy group may be 5% by mass or less, less than 5% by mass, 1% by mass or less, 0.10% by mass or less, 0.01% by mass or less, or substantially 0% by mass, based on the total mass of the (meth)acrylic compound or the total mass of the methacrylic compound.

The molecular weight of the (meth)acrylic compound or the methacrylic compound may be in the following range from the viewpoint of adjusting the tensile elastic modulus of the cured product and the viewpoint of easily obtaining excellent dielectric properties (a low dielectric constant, dielectric dissipation factor, or the like) in the cured product. The molecular weight may be 80 or more, 100 or more, 120 or more, 150 or more, 180 or more, 200 or more, 220 or more, 250 or more, 260 or more, 280 or more, 290 or more, 300 or more, or 320 or more. The molecular weight may be 1000 or less, 800 or less, 600 or less, 550 or less, 500 or less, 450 or less, 400 or less, 350 or less, 320 or less, 300 or less, or 280 or less. From these viewpoints, the molecular weight may be 80 to 1000, 80 to 500, 80 to 400, 80 to 300, 100 to 1000, 100 to 500, 100 to 400, 100 to 300, 200 to 1000, 200 to 500, 200 to 400, 200 to 300, 250 to 1000, 250 to 500, 250 to 400, 250 to 300, 300 to 1000, 300 to 500, or 300 to 400.

As the content of the (meth)acrylic compound or the content of the methacrylic compound, a content B1 may be in the following range with respect to 100 parts by mass of a polymer (a polymer contained in the resin composition) or 100 parts by mass of the styrene-based block copolymer, from the viewpoint of easily obtaining a high tensile elastic modulus in the cured product and the viewpoint of easily obtaining excellent dielectric properties (a low dielectric constant, dielectric dissipation factor, or the like) in the cured product. The content B1 may be 1 part by mass or more, 5 parts by mass or more, 10 parts by mass or more, 15 parts by mass or more, 20 parts by mass or more, or 25 parts by mass or more. The content B1 may be 300 parts by mass or less, 200 parts by mass or less, 100 parts by mass or less, 80 parts by mass or less, 60 parts by mass or less, 50 parts by mass or less, 40 parts by mass or less, 30 parts by mass or less, or 25 parts by mass or less. From these viewpoints, the content B1 may be 1 to 300 parts by mass, 10 to 300 parts by mass, 20 to 300 parts by mass, 1 to 100 parts by mass, 10 to 100 parts by mass, 20 to 100 parts by mass, 1 to 50 parts by mass, 10 to 50 parts by mass, or 20 to 50 parts by mass. As the content of the (meth)acrylic compound or the content of the methacrylic compound, a content B2 may be in the following range based on the total mass of the resin composition (excluding the mass of an organic solvent), the total amount of a polymer (a polymer contained in the resin composition), the (meth)acrylic compound, and the polymerization initiator, the total amount of a polymer (a polymer contained in the resin composition), the methacrylic compound, and the polymerization initiator, the total amount of the styrene-based block copolymer, the (meth)acrylic compound, and the polymerization initiator, the total amount of the styrene-based block copolymer, the methacrylic compound, and the polymerization initiator, the total amount of a polymer (a polymer contained in the resin composition) and the (meth)acrylic compound, the total amount of a polymer (a polymer contained in the resin composition) and the methacrylic compound, the total amount of the styrene-based block copolymer and the (meth)acrylic compound, or the total amount of the styrene-based block copolymer and the methacrylic compound, from the viewpoint of easily obtaining a high tensile elastic modulus in the cured product and the viewpoint of easily obtaining excellent dielectric properties (a low dielectric constant, dielectric dissipation factor, or the like) in the cured product. The content B2 may be 1% by mass or more, 5% by mass or more, 10% by mass or more, 15% by mass or more, 18% by mass or more, or 20% by mass or more. The content B2 may be 80% by mass or less, less than 80% by mass, 70% by mass or less, less than 70% by mass, 60% by mass or less, less than 60% by mass, 50% by mass or less, less than 50% by mass, 40% by mass or less, 35% by mass or less, 30% by mass or less, 25% by mass or less, or 20% by mass or less. From these viewpoints, the content B2 may be 1 to 80% by mass, 1 to 50% by mass, 1 to 30% by mass, 10 to 80% by mass, 10 to 50% by mass, 10 to 30% by mass, 15 to 80% by mass, 15 to 50% by mass, or 15 to 30% by mass.

The resin composition of the present embodiment contains the polymerization initiator. The polymerization initiator is not particularly limited as long as it is a compound that initiates polymerization by heating, irradiation with an active ray (an ultraviolet ray or the like), or the like, and examples thereof include a thermal polymerization initiator and a photopolymerization initiator (excluding a compound corresponding to the thermal polymerization initiator).

Examples of the thermal polymerization initiator include ketone peroxides such as methyl ethyl ketone peroxide, cyclohexanone peroxide, and methyl cyclohexanone peroxide; peroxyketals such as 1,1-bis(tert-butyl peroxy)cyclohexane, 1,1-bis(tert-butyl peroxy)-2-methyl cyclohexane, 1,1-bis(tert-butyl peroxy)-3,3,5-trimethyl cyclohexane, 1,1-bis(tert-hexyl peroxy)cyclohexane, and 1,1-bis(tert-hexyl peroxy)-3,3,5-trimethyl cyclohexane; hydroperoxides such as p-menthane hydroperoxide; dialkyl peroxides such as α,α′-bis(tert-butyl peroxy)diisopropyl benzene, dicumyl peroxide, tert-butyl cumyl peroxide, and di-tert-butyl peroxide; diacyl peroxides such as octanoyl peroxide, lauroyl peroxide, stearyl peroxide, and benzoyl peroxide; peroxycarbonates such as bis(4-tert-butyl cyclohexyl) peroxydicarbonate, di-2-ethoxy ethyl peroxydicarbonate, di-2-ethyl hexyl peroxydicarbonate, and di-3-methoxy butyl peroxycarbonate; peroxyesters such as tert-butyl peroxypivalate, tert-hexyl peroxypivalate, 1,1,3,3-tetramethylbutyl peroxy-2-ethyl hexanoate, 2,5-dimethyl-2,5-bis(2-ethylhexanoylperoxy)hexane, tert-hexyl peroxy-2-ethyl hexanoate, tert-butyl peroxy-2-ethyl hexanoate, tert-butyl peroxyisobutyrate, tert-hexyl peroxyisopropyl monocarbonate, tert-butyl peroxy-3,5,5-trimethyl hexanoate, tert-butyl peroxylaurylate, tert-butyl peroxyisopropyl monocarbonate, tert-butyl peroxy-2-ethyl hexyl monocarbonate, tert-butyl peroxybenzoate, tert-hexyl peroxybenzoate, 2,5-dimethyl-2,5-bis(benzoyl peroxy)hexane, and tert-butyl peroxyacetate; acid anhydrides such as a phthalic anhydride, a maleic anhydride, a trimellitic anhydride, a hexahydrophthalic anhydride, a tetrahydrophthalic anhydride, a methyl nadic anhydride, a nadic anhydride, a glutaric anhydride, a dimethyl glutaric anhydride, a diethyl glutaric anhydride, a succinic anhydride, a methyl hexahydrophthalic anhydride, a methyl tetrahydrophthalic anhydride, a 1,2,3,4-cyclobutane tetracarboxylic dianhydride, a 4,4′-biphthalic anhydride, a 4,4′-carbonyl diphthalic anhydride, a 4,4′-sulfonyl diphthalic anhydride, a 4,4′-(hexafluoroisopropylidene) diphthalic anhydride, a 4,4′-oxydiphthalic anhydride, a 9,9-bis(3,4-dicarboxyphenyl) fluorene dianhydride, and a 2,3,6,7-naphthalene tetracarboxylic dianhydride; and azo compounds such as 2,2′-azobisisobutyronitrile, 2,2′-azobis(2,4-dimethyl valeronitrile), and 2,2′-azobis(4-methoxy-2′-dimethyl valeronitrile).

Examples of the photopolymerization initiator include an acylphosphine oxide compound, an acetophenone compound, an anthraquinone compound, a benzophenone compound, an imidazole compound, an acridine compound, and an oxime ester compound.

The polymerization initiator may include a thermal polymerization initiator, may include a thermal radical polymerization initiator, and may include a thermal cationic polymerization initiator, from the viewpoint of easily obtaining a high tensile elastic modulus in the cured product and the viewpoint of easily obtaining excellent dielectric properties (a low dielectric constant, dielectric dissipation factor, or the like) in the cured product. The polymerization initiator may include a peroxide, may include a peroxyester, and may include 2,5-dimethyl-2,5-bis(2-ethylhexanoylperoxy)hexane, from the viewpoint of easily obtaining a high tensile elastic modulus in the cured product and the viewpoint of easily obtaining excellent dielectric properties (a low dielectric constant, dielectric dissipation factor, or the like) in the cured product.

The content of the polymerization initiator may be in the following range based on the total mass of the resin composition (excluding the mass of an organic solvent), the total amount of a polymer (a polymer contained in the resin composition), the (meth)acrylic compound, and the polymerization initiator, the total amount of a polymer (a polymer contained in the resin composition), the methacrylic compound, and the polymerization initiator, the total amount of the styrene-based block copolymer, the (meth)acrylic compound, and the polymerization initiator, the total amount of the styrene-based block copolymer, the methacrylic compound, and the polymerization initiator, the total amount of a polymer (a polymer contained in the resin composition) and the (meth)acrylic compound, the total amount of a polymer (a polymer contained in the resin composition) and the methacrylic compound, the total amount of the styrene-based block copolymer and the (meth)acrylic compound, or the total amount of the styrene-based block copolymer and the methacrylic compound. The content of the polymerization initiator may be 0.01% by mass or more, 0.05% by mass or more, 0.1% by mass or more, more than 0.10% by mass, 0.3% by mass or more, 0.5% by mass or more, 0.8% by mass or more, 0.9% by mass or more, or 1% by mass or more, from the viewpoint of easily obtaining a high tensile elastic modulus in the cured product, the viewpoint of easily obtaining excellent dielectric properties (a low dielectric constant, dielectric dissipation factor, or the like) in the cured product, and the viewpoint of easily obtaining excellent curability. The content of the polymerization initiator may be 10% by mass or less, 8% by mass or less, 5% by mass or less, 3% by mass or less, 2% by mass or less, less than 2% by mass, 1.5% by mass or less, or 1% by mass or less, from the viewpoint of easily obtaining a high tensile elastic modulus in the cured product and the viewpoint of easily obtaining excellent dielectric properties (a low dielectric constant, dielectric dissipation factor, or the like) in the cured product. From these viewpoints, the content of the polymerization initiator may be 0.01 to 10% by mass, 0.01 to 5% by mass, 0.01 to 2% by mass, 0.1 to 10% by mass, 0.1 to 5% by mass, 0.1 to 2% by mass, 0.5 to 10% by mass, 0.5 to 5% by mass, or 0.5 to 2% by mass.

The resin composition of the present embodiment may contain an additive other than the styrene-based block copolymer, the (meth)acrylic compound, and the polymerization initiator. Examples of such an additive include a polymer (excluding a compound corresponding to the styrene-based block copolymer), a polymerizable compound (excluding a compound corresponding to the (meth)acrylic compound), a curing accelerator, an antioxidant, an ultraviolet absorber, a visible light absorber, a colorant, a plasticizer, a stabilizer, a filling agent (filler), a reducing agent, and a hydrogencarbonate. Examples of the polymerizable compound include a vinylidene halide compound, a vinyl ether compound, a vinyl ester compound, a vinyl amide compound, an aromatic vinyl compound (for example, a vinylpyridine compound), an allyl compound, and an epoxy compound. Examples of the reducing agent include vanadyl acetylacetonate, vanadium acetylacetonate, cobalt acetylacetonate, copper acetylacetonate, vanadyl naphthenate, vanadyl stearate, copper naphthenate, copper acetate, and cobalt octylate.

The content of the filling agent (filler) may be 100% by mass or less, less than 100% by mass, 50% by mass or less, 20% by mass or less, less than 20% by mass, 10% by mass or less, 10% by mass or less, 0.10% by mass or less, or substantially 0% by mass, based on the total amount of a polymer (a polymer contained in the resin composition) and the (meth)acrylic compound, the total amount of a polymer (a polymer contained in the resin composition) and the methacrylic compound, the total amount of the styrene-based block copolymer and the (meth)acrylic compound, or the total amount of the styrene-based block copolymer and the methacrylic compound. The content of the reducing agent may be 0.01 parts by mass or less, less than 0.01 parts by mass, 0.001 parts by mass or less, or substantially 0 parts by mass, with respect to 100 parts by mass of the (meth)acrylic compound or 100 parts by mass of the methacrylic compound. The content of the hydrogencarbonate may be 0.1 parts by mass or less, less than 0.1 parts by mass, 0.01 parts by mass or less, 0.001 parts by mass or less, or substantially 0 parts by mass, with respect to 100 parts by mass of the (meth)acrylic compound or 100 parts by mass of the methacrylic compound.

The resin composition of the present embodiment may contain an organic solvent. The resin composition of the present embodiment may be used as a resin varnish by diluting with the organic solvent. Examples of the organic solvent include aromatic hydrocarbons such as toluene, xylene, mesitylene, cumene, and p-cymene; cyclic ethers such as tetrahydrofuran and 1,4-dioxane; ketones such as acetone, methyl ethyl ketone, methyl isobutyl ketone, cyclohexanone, and 4-hydroxy-4-methyl-2-pentanone; esters such as methyl acetate, ethyl acetate, butyl acetate, methyl lactate, ethyl lactate, and γ-butyrolactone; carbonate esters such as ethylene carbonate and propylene carbonate; and amides such as N,N-dimethylformamide, N,N-dimethylacetamide, and N-methyl pyrrolidone.

The total light transmittance per 100 μm of the thickness of a layer containing the resin composition of the present embodiment or the cured product of the present embodiment may be 90% or more or 91% or more. The total light transmittance can be measured according to the method specified in JIS K 7136, for example, using NDH-5000 (trade name) manufactured by NIPPON DENSHOKU INDUSTRIES CO., LTD. The total light transmittance described below can also be measured by the same method.

A laminate of the present embodiment has a base material film (a support film) and a transparent resin layer disposed on the base material film, and the transparent resin layer contains at least one selected from the group consisting of the resin composition and the cured product thereof of the present embodiment.

Examples of the constituent material of the base material film include polyester (polyethylene terephthalate (PET), polybutylene terephthalate, polyethylene naphthalate, and the like), polyolefin (polyethylene, polypropylene, a cycloolefin polymer, and the like), polycarbonate, polyamide, polyimide, polyamide imide, polyether imide, polyether sulfide, polyether sulfone, polyether ketone, polyphenylene ether, and polyphenylene sulfide. The thickness of the base material film may be 1 to 200 μm, 10 to 100 μm, 20 to 80 μm, or 20 to 50 μm.

The thickness of the transparent resin layer may be 1000 μm or less, 800 μm or less, 500 μm or less, 300 μm or less, 250 μm or less, 200 μm or less, 150 μm or less, 100 μm or less, 80 μm or less, 50 μm or less, 30 μm or less, 25 μm or less, 20 μm or less, 15 μm or less, 12 μm or less, 10 μm or less, 9 μm or less, or 8 μm or less, from the viewpoint of easily obtaining excellent transmittance and the viewpoint of easily reducing the transparent antenna in thickness. The thickness of the transparent resin layer may be 0.1 μm or more, 0.5 μm or more, 0.75 μm or more, 1 μm or more, 2 μm or more, 3 μm or more, 5 μm or more, 6 μm or more, 7 μm or more, 8 μm or more, 10 μm or more, 20 μm or more, 30 μm or more, 40 μm or more, 50 μm or more, 80 μm or more, or 100 μm or more, from the viewpoint of easily reducing the transmission loss and the viewpoint of easily improving antenna characteristics. From these viewpoints, the thickness of the transparent resin layer may be 0.1 to 1000 μm, 1 to 1000 μm, 10 to 500 μm, 20 to 200 μm, 50 to 200 μm, 0.1 to 500 μm, 0.1 to 100 μm, 0.5 to 250 μm, 0.5 to 150 μm, 0.75 to 100 μm, 1 to 50 μm, 2 to 30 μm, 3 to 20 μm, or 5 to 20 μm.

A first aspect of the laminate of the present embodiment may have a protective film disposed on the transparent resin layer. A second aspect of the laminate of the present embodiment may have a conductive member disposed on the transparent resin layer.

As the constituent material of the protective film, the material described above as the constituent material of the base material film can be used. The protective film may be the same film as the base material film, and may be a film different from the base material film. The thickness of the protective film may be 1 to 200 μm, 10 to 100 μm, 20 to 80 μm, or 20 to 50 μm.

The conductive member may be solid, and may have a pattern-shaped portion (may be patterned). In the conductive member having a pattern-shaped portion (hereinafter, referred to as a “pattern-shaped conductive member”), a part of the conductive member or the entire conductive member may be patterned (the same applies to the following description regarding the conductive member having a pattern-shaped portion). Examples of the shape of the pattern-shaped portion include a mesh shape and a spiral shape. In the case of using the transparent antenna having a solid conductive member, the conductive member may not be patterned (for example, may not be subjected to mesh processing). The pattern-shaped (for example, mesh-shaped) conductive member may be formed of a wire (for example, a metal wire). Examples of the constituent material of the conductive member include a metal material, a carbon material (for example, graphene), and a conductive polymer. Examples of the metal material include copper, silver, and gold. The conductive member may contain copper from the viewpoint of easily obtaining excellent conductivity and the viewpoint of easily reducing a manufacturing cost.

The conductive member may be a single layer, and may be a plurality of layers. The conductive member of the plurality of layers may include, for example, a first conductive member (for example, a metal member) disposed on the transparent resin layer, and a second conductive member (for example, a metal member) disposed on the first conductive member. At least one selected from the group consisting of the first conductive member and the second conductive member may be solid, and may have a pattern-shaped (for example, mesh-shaped) portion. The second conductive member can be used as a protective layer suppressing the contamination, the damage, or the like of the first conductive member, and therefore, the handleability of the laminate can also be improved. At least one selected from the group consisting of the first conductive member and the second conductive member may contain copper.

The thickness of the conductive member (the total thickness in a case where the conductive member is a plurality of layers), the thickness of the first conductive member or the thickness of the second conductive member may be in the following range. The thickness may be 50 μm or less, 45 μm or less, 40 μm or less, 35 μm or less, 30 μm or less, 25 μm or less, 20 μm or less, 18 μm or less, 15 μm or less, 10 μm or less, 8 μm or less, 5 μm or less, 3 μm or less, or 2 μm or less, from the viewpoint of making the conductive member hard to chip and the viewpoint of easily patterning the solid conductive member in a case where the solid conductive member is patterned (for example, is subjected to the mesh processing). The thickness may be 0.1 μm or more, 0.3 μm or more, 0.5 μm or more, 0.8 μm or more, 1 μm or more, 1.2 μm or more, 1.5 μm or more, or 2 μm or more, from the viewpoint of easily obtaining excellent elongation. From these viewpoints, the thickness may be 0.1 to 50 μm, 0.1 to 30 μm, 0.1 to 20 μm, 0.1 to 10 μm, 0.5 to 5 μm, or 1 to 3 μm.

The thickness of the first conductive member may be smaller than the thickness of the second conductive member. In a case where the conductive member is a plurality of layers, the thickness (the total thickness) of the conductive member or the thickness of the second conductive member may be 3 μm or more, 5 μm or more, 8 μm or more, 10 μm or more, 15 μm or more, 18 μm or more, or 20 μm or more.

The laminate of the second aspect may have a protective film disposed on the conductive member. As the protective film, the protective film described above as the protective film of the laminate of the first aspect can be used. At least a part of the surface of the protective film on the side of the conductive member may be subjected to a release treatment, and a release layer may be disposed on at least a part of the surface of the protective film on the side of the conductive member. For example, the laminate of the second aspect may be an embodiment having a base material film, a transparent resin layer, a conductive member, and a protective film, in which the conductive member is a single layer, and at least a part of the surface of the protective film on the side of the conductive member is subjected to a release treatment.

The laminate of the second aspect may have a layer L disposed on the conductive member as a layer containing at least one selected from the group consisting of a photosensitive composition and a cured product thereof. The photosensitive composition has photosensitivity with respect to an active ray (an ultraviolet ray or the like), and may have positive photosensitivity, and may have negative photosensitivity. The photosensitive composition may have photo-curability of curing by light irradiation. The layer L may be either before or after light irradiation, and may have at least one selected from the group consisting of an uncured portion and a cured portion. The layer L may be either before or after light irradiation, and may have at least one selected from the group consisting of an unexposed portion and an exposed portion. The constituent material of the photosensitive composition is not particularly limited.

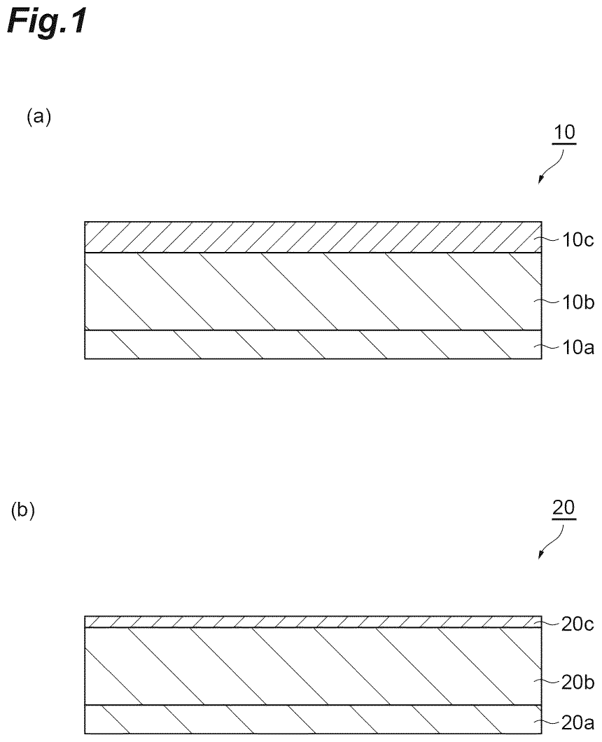

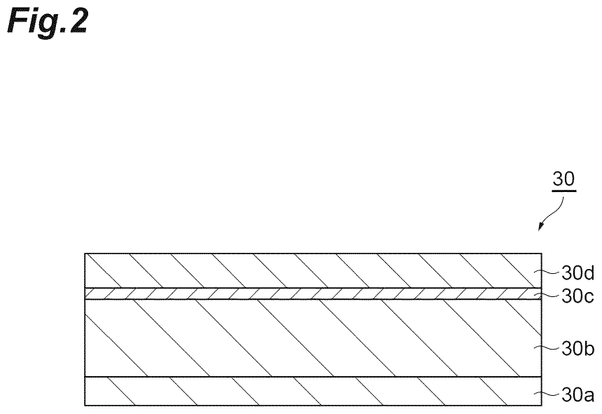

FIG. 1 and FIG. 2 are schematic sectional views illustrating an example of the laminate. A laminate 10 in FIG. 1(a) has a base material film 10a, a transparent resin layer 10b disposed on the base material film 10a, and a protective film 10c disposed on the transparent resin layer 10b. The transparent resin layer 10b is composed of the resin composition of the present embodiment or the cured product of the present embodiment. A laminate 20 in FIG. 1(b) has a base material film 20a, a transparent resin layer 20b disposed on the base material film 20a, and a conductive member 20c disposed on the transparent resin layer 20b. The transparent resin layer 20b is composed of the resin composition of the present embodiment or the cured product of the present embodiment. A laminate 30 in FIG. 2 has a base material film 30a, a transparent resin layer 30b disposed on the base material film 30a, a conductive member 30c disposed on the transparent resin layer 30b, and a conductive member 30d disposed on the conductive member 30c. The transparent resin layer 30b is composed of the resin composition of the present embodiment or the cured product of the present embodiment.

The resin composition and the cured product thereof of the present embodiment can be used in the transparent antenna and a manufacturing method therefor. In the transparent antenna, a location to which the resin composition and the cured product thereof of the present embodiment are applied is not particularly limited. As for the case of using the resin composition of the present embodiment, hereinafter, a base material obtained by curing the resin composition of the transparent resin layer in a curing step is referred to as a “transparent base material”, and a layer that may include a state before the resin composition of the transparent resin layer is cured in the curing step is referred to as a “transparent resin layer”.

A first aspect of the transparent antenna of the present embodiment has a transparent base material and a conductive member disposed on the transparent base material, in which the transparent base material contains a cured product of the resin composition of the present embodiment. The transparent antenna of the first aspect may have a covering member disposed on the conductive member, and the covering member may contain a cured product of the resin composition of the present embodiment and may not contain a cured product of the resin composition of the present embodiment (may contain a cured product of a resin composition not corresponding to the resin composition of the present embodiment). A second aspect of the transparent antenna of the present embodiment has a conductive member and a covering member disposed on the covering member, in which the covering member contains a cured product of the resin composition of the present embodiment. The second aspect of the transparent antenna of the present embodiment may have a transparent base material, and the conductive member may be disposed on the transparent base material. In the transparent antenna of the second aspect, the transparent base material may contain a cured product of the resin composition of the present embodiment, and may not contain a cured product of the resin composition of the present embodiment (may contain a cured product of a resin composition not corresponding to the resin composition of the present embodiment). The transparent antenna of the present embodiment may be an embodiment having a transparent base material, a conductive member disposed on the transparent base material, and a covering member disposed on the conductive member, in which at least one selected from the group consisting of the transparent base material and the covering member contains a cured product of the resin composition of the present embodiment.

In the transparent antenna of the present embodiment, the covering member may be disposed on at least a part (a part or the entire) of the conductive member. The covering member may be disposed on at least a part (a part or the entire) of the transparent base material. The covering member may have a portion disposed on the transparent base material without being disposed on the conductive member, in addition to a portion disposed on the conductive member. By disposing the conductive member on a part of the transparent base material (for example, a part of the main surface of the transparent base material), the covering member (transparent member) may be disposed on the transparent base material and the conductive member. The covering member can protect the conductive member by covering the conductive member. The covering member can protect the transparent base material by covering the transparent base material.

The covering member may be in contact with the conductive member. The covering member may be in contact with the transparent base material, and may not be in contact with the transparent base material. The transparent base material may be in contact with a transparent member (for example, a support member described below) different from the covering member. The covering member may be in contact with a transparent member (for example, a protective member described below) different from the transparent base material.

In the transparent antenna of the present embodiment, at least one member selected from the group consisting of the transparent base material and the covering member can contain a cured product of the resin composition of the present embodiment. In a case where one member (hereinafter, referred to as “member A”) of the transparent base material and the covering member does not contain a cured product of the resin composition of the present embodiment, the member A may be formed of a material having a total light transmittance of 90% or more or 91% or more per 100 μm of the thickness. Examples of the constituent material of the member A include polyolefin (polyethylene, polypropylene, a cycloolefin polymer (COP), and the like), polyester (polyethylene terephthalate (PET), polybutylene terephthalate, polyethylene naphthalate, and the like), polycarbonate, polyamide, polyimide, polyamide imide, polyether imide, polyether sulfide, polyether sulfone, polyether ketone, polyphenylene ether, and polyphenylene sulfide. For example, the member A may contain a cycloolefin polymer.

In the transparent antenna of the present embodiment, as the configuration of the conductive member, the configuration described above regarding the conductive member of the laminate of the second aspect can be used. For example, the conductive member may contain copper. The conductive member may be solid, and may have a pattern-shaped (for example, mesh-shaped) portion. The conductive member may be a single layer. As the thickness of the transparent base material, the thickness described above regarding the transparent resin layer of the laminate of the present embodiment can be used.

The transparent antenna of the present embodiment may have a support member supporting the transparent base material, that is, may have a support member, a transparent base material disposed on the support member, and a conductive member disposed on the transparent base material. The transparent antenna of the present embodiment may have a protective member disposed on the covering member, that is, may have a transparent base material, a conductive member disposed on the transparent base material, a covering member disposed on the conductive member, and a protective member disposed on the covering member.

The shapes of the support member and the protective member are not particularly limited, and may be a film shape, a substrate shape, an irregular shape, or the like. Examples of the constituent materials of the support member and the protective member include a resin material and an inorganic material. Examples of the resin material include polyolefin (polyethylene, polypropylene, a cycloolefin polymer, and the like), polyester (polyethylene terephthalate (PET), polybutylene terephthalate, polyethylene naphthalate, and the like), polycarbonate, polyamide, polyimide, polyamide imide, polyether imide, polyether sulfide, polyether sulfone, polyether ketone, polyphenylene ether, and polyphenylene sulfide. Examples of the inorganic material include glass. The support member and the protective member are not limited to being transparent, and may be a transparent member (a transparent film, a transparent substrate, or the like), and may be a non-transparent member. The support member and the protective member may be formed of a material having a total light transmittance of 90% or more per 100 μm of the thickness. The support member may contain a polyolefin from the viewpoint of low dielectric.

As a method for obtaining the transparent antenna of the first aspect, a first aspect of the manufacturing method for a transparent antenna of the present embodiment includes a processing step of patterning (for example, processing into a mesh shape) at least a part of the conductive member (the solid conductive member) disposed on the transparent resin layer containing at least one selected from the group consisting of the resin composition and the cured product thereof of the present embodiment. In the processing step, a pattern-shaped (for example, mesh-shaped) conductive member may be obtained by etching a conductive member in a state where a pattern-shaped resist layer is disposed on the conductive member of the laminate having the transparent resin layer and the conductive member disposed on the transparent resin layer. The resist layer may be removed after the conductive member is etched. The pattern-shaped resist layer can be obtained by removing an uncured portion or a cured portion of a photosensitive layer (a layer containing a photosensitive composition) disposed on the conductive member. For example, the pattern-shaped resist layer can be obtained by irradiating (exposing) photosensitive layer (a layer containing a photosensitive composition) disposed on the conductive member with an active ray (for example, an ultraviolet ray), and then removing (developing) the unexposed portion (in a case where the photosensitive layer has negative photosensitivity) or the exposed portion (in a case where the photosensitive layer has positive photosensitivity) of the photosensitive layer. As the photosensitive layer, the aforementioned layer L can be used.

The laminate having the conductive member disposed on the transparent resin layer may be obtained by forming the conductive member on the transparent resin layer containing at least one selected from the group consisting of the resin composition and the cured product thereof of the present embodiment, and may be obtained by, for example, removing the protective film of the laminate of the first aspect and then forming the conductive member on the transparent resin layer. The laminate having the conductive member disposed on the transparent resin layer may be the laminate of the second aspect.

The manufacturing method for a transparent antenna of the first aspect may include a curing step of curing the transparent resin layer (the resin composition of the transparent resin layer) to obtain a cured product (transparent base material), before the processing step, after the processing step, or before and after the processing step. In the curing step, the resin composition may be cured by irradiating an uncured resin composition with an active ray, and the resin composition may be cured by heating the uncured resin composition. The active ray is not particularly limited, and an ultraviolet ray may be used, and an ultraviolet ray with a wavelength of 365 nm may be used. The resin composition may be irradiated with the active ray through a light-transmitting film (for example, the base material film or the protective film of the laminate of the present embodiment). A curing step in another aspect of the manufacturing method for a transparent antenna described below may be the same as the curing step in the manufacturing method for a transparent antenna of the first aspect.

As a method for obtaining the transparent antenna of the first aspect, a second aspect of the manufacturing method for a transparent antenna of the present embodiment includes a forming step of forming a pattern-shaped (for example, mesh-shaped) conductive member in a state where a pattern-shaped resist layer is disposed on a transparent resin layer containing at least one selected from the group consisting of the resin composition and the cured product thereof of the present embodiment.

In the forming step, the pattern-shaped (for example, mesh-shaped) conductive member may be formed by plating or sputtering using the resist layer as a mask. The resist layer may be removed after the forming step. The manufacturing method for a transparent antenna of the second aspect may include a curing step of curing the transparent resin layer (the resin composition of the transparent resin layer) to obtain a cured product (transparent base material), before the forming step, after the forming step, or before and after the forming step.

A third aspect of the manufacturing method for a transparent antenna of the present embodiment includes a removing step of removing the base material film of the laminate of the second aspect. The conductive member of the laminate of the second aspect may have a pattern-shaped (for example, mesh-shaped) portion. In a case where the transparent resin layer of the laminate at the time of the removing step contains a cured product (in a case where the transparent resin layer is a transparent base material), a laminate of the transparent base material and the conductive member (the pattern-shaped (for example, mesh-shaped) conductive member, or the like) can be obtained as the transparent antenna by the removing step. The manufacturing method for a transparent antenna of the third aspect may include a curing step of curing the transparent resin layer (the resin composition of the transparent resin layer) to obtain a cured product (transparent base material), before the removing step, after the removing step, or before and after the removing step.

A fourth aspect of the manufacturing method for a transparent antenna of the present embodiment includes a laminating step of laminating the transparent resin layer of the laminate of the present embodiment on the support member. As the support member, the support member described above regarding the transparent antenna can be used. In the laminating step, the transparent resin layer may be laminated on the support member in a state where the base material film of the laminate of the present embodiment is removed, and the transparent resin layer may be laminated on the support member in a state where the protective film of the laminate of the first aspect is removed. The manufacturing method for a transparent antenna of the fourth aspect may include a removing step A of removing the base material film of the laminate of the present embodiment, and may include a removing step B of removing the protective film of the laminate of the first aspect.

In the case of using the laminate of the second aspect, in the laminating step, the transparent resin layer and the conductive member may be laminated on the support member in a state where the transparent resin layer is positioned closer to the side of the support member than the conductive member, and the transparent resin layer and the conductive member may be laminated on the support member in a state where the transparent resin layer is in contact with the support member. In the laminating step, the conductive member may be solid, and may have a pattern-shaped (for example, mesh-shaped) portion. In the laminating step, the transparent resin layer and the conductive member can be laminated on the support member in a state where the base material film of the laminate of the second aspect is removed. In a case where the laminate of the second aspect has the protective film disposed on the conductive member, in the laminating step, the transparent resin layer, the conductive member, and the protective film may be laminated on the support member in a state where the transparent resin layer is positioned closer to the side of the support member than the conductive member (in a state where the conductive member is positioned closer to the side of the transparent resin layer than the protective film). In a case where the laminate of the second aspect has the base material film, the transparent resin layer, the conductive member, and the protective film, the manufacturing method for a transparent antenna of the fourth aspect may include a removing step B of removing the protective film after the removing step A and the laminating step. In a case where the laminate of the second aspect has the aforementioned layer L, in the laminating step, the transparent resin layer, the conductive member, and the layer L may be laminated on the support member in a state where the transparent resin layer is positioned closer to the side of the support member than the conductive member.

Incidentally, in a laminate having a support member and a conductive member disposed on the support member, in the case of laminating the support member and the conductive member with excellent adhesiveness, there is a case where the support member is subjected to a surface treatment (a plasma treatment, a corona treatment, or the like), and the manufacturing procedure of the laminate may be complicated. For example, in the case of using a polyolefin as the constituent material of the support member, since adhesiveness between the polyolefin and the conductive member (for example, a metal material such as copper) is low, there is a case where the surface treatment is required to be performed in order to obtain sufficient adhesiveness. On the other hand, according to the manufacturing method for a transparent antenna of the fourth aspect, it is possible to obtain the laminate of the support member and the conductive member (the laminate having the support member, the transparent base material, and the conductive member) as the transparent antenna while obtaining sufficient adhesiveness between the support member and the conductive member with the transparent base material interposed therebetween, and for example, it is possible to obtain the transparent antenna while obtaining sufficient adhesiveness between the support member containing a polyolefin and the conductive member containing copper with the transparent base material interposed therebetween. Furthermore, according to the manufacturing method for a transparent antenna of the fourth aspect, it is possible to collectively supply the transparent resin layer and the conductive member onto the support member by laminating the laminate of the second aspect on the support member, and it is possible to obtain the transparent antenna by a simple method without requiring to form each member on the support member each time the transparent antenna is manufactured. In a case where the laminate of the second aspect has the aforementioned layer L, according to the manufacturing method for a transparent antenna of the fourth aspect, it is possible to collectively supply the transparent resin layer, the conductive member and the layer L onto the support member by laminating the laminate of the second aspect on the support member, and it is possible to obtain the transparent antenna by a simple method without requiring to form each member on the support member each time the transparent antenna is manufactured. Further, according to the manufacturing method for a transparent antenna of the fourth aspect, it is possible to obtain the transparent antenna having excellent antenna characteristics by using a material having excellent dielectric properties (a low dielectric constant, a dielectric dissipation factor, or the like) as the constituent material of the transparent resin layer or the transparent base material.

In the manufacturing method for a transparent antenna of the fourth aspect, the transparent resin layer in the removing step A, the removing step B, and the laminating step may be uncured and may be a cured product. The manufacturing method for a transparent antenna of the fourth aspect may include a curing step of curing the transparent resin layer (the resin composition of the transparent resin layer) to obtain a cured product (transparent base material), before the removing step A, before the removing step B, before the laminating step, after the removing step A, after the removing step B, after the laminating step, before and after the removing step A, before and after the removing step B, or before and after the laminating step.

In the manufacturing method for a transparent antenna of the fourth aspect, the conductive member in the removing step A, the removing step B, and the laminating step may be solid, and may have a pattern-shaped (for example, mesh-shaped) portion. In a case where the conductive member is solid, the manufacturing method for a transparent antenna of the fourth aspect may include a processing step A of patterning (for example, processing into a mesh shape) at least a part of the conductive member after the laminating step. In the processing step A, at least a part of the conductive member may be patterned by etching at least a part of the conductive member using the pattern-shaped resist layer as a mask. As an embodiment in which the conductive member has a pattern-shaped portion in the laminating step, the manufacturing method for a transparent antenna of the fourth aspect may be an embodiment in which the manufacturing method includes a laminating step of laminating, on the support member, a laminate having a transparent resin layer and a conductive member disposed on the transparent resin layer in a state where the transparent resin layer of the laminate is positioned closer to the side of the support member than the conductive member, the transparent resin layer contains at least one selected from the group consisting of the resin composition and the cured product thereof of the present embodiment, and the conductive member has a pattern-shaped portion.

In a case where the laminate of the second aspect has the aforementioned layer L, the manufacturing method for a transparent antenna of the fourth aspect may include a processing step B of patterning at least a part of the layer L to obtain the pattern-shaped layer L (resist layer) after the laminating step and before the processing step A. In the processing step B, it is possible to pattern at least a part of the layer L by removing (developing) the unexposed portion (in a case where the layer L has negative photosensitivity) or the exposed portion (in a case where the layer L has positive photosensitivity), and at least a part of the layer L may be patterned by exposing the layer L and then removing (developing) the unexposed portion or the exposed portion. The manufacturing method for a transparent antenna of the fourth aspect may include a step of exposing at least a part of the layer L before the laminating step. As an embodiment using the laminate having a layer containing at least one selected from the group consisting of a photosensitive composition and a cured product thereof, the manufacturing method for a transparent antenna of the fourth aspect may be an embodiment in which the manufacturing method includes a laminating step of laminating, on the support member, a laminate having a first layer, a second layer, a conductive member disposed between the first layer and the second layer in a state where the first layer of the laminate is positioned closer to the side of the support member than the second layer, the first layer contains at least one selected from the group consisting of the resin composition and the cured product thereof of the present embodiment, and the second layer contains at least one of a photosensitive composition and a cured product thereof.

In the manufacturing method for a transparent antenna of the fourth aspect, the conductive member in the removing step A, the removing step B, and the laminating step may be a plurality of layers and may have a first conductive member disposed on the transparent resin layer and a second conductive member disposed on the first conductive member. At least one selected from the group consisting of the first conductive member and the second conductive member may be solid, and may have a pattern-shaped (for example, mesh-shaped) portion. At least one selected from the group consisting of the first conductive member and the second conductive member may contain copper. In a case where the conductive member has the first conductive member and the second conductive member, in the laminating step, the transparent resin layer and the conductive member may be laminated on the support member in a state where the first conductive member is positioned closer to the side of the support member than the second conductive member. The manufacturing method for a transparent antenna of the fourth aspect may include a removing step C of removing the second conductive member after the laminating step. In the removing step C, the second conductive member can be peeled off from the first conductive member. The manufacturing method for a transparent antenna of the fourth aspect may include a processing step of patterning (for example, processing into a mesh shape) at least a part of the first conductive member after the removing step C. In the processing step, for example, the first conductive member may be etched in a state where a pattern-shaped resist layer is disposed on the first conductive member. The manufacturing method for a transparent antenna of the fourth aspect may include a curing step of curing the transparent resin layer (the resin composition of the transparent resin layer) to obtain a cured product (transparent base material), before the removing step C, after the removing step C, or before and after the removing step C.

As a method for obtaining the transparent antenna of the first aspect, a fifth aspect of the manufacturing method for a transparent antenna of the present embodiment is a manufacturing method for a transparent antenna by using the laminate (the laminate of the second aspect) having the aforementioned base material film, the aforementioned transparent resin layer (the transparent resin layer containing at least one selected from the group consisting of the resin composition and the cured product thereof of the present embodiment), and the aforementioned conductive member having the first conductive member and the second conductive member, the manufacturing method including a removing step C of removing the second conductive member in a state where the transparent resin layer and the conductive member are laminated on the support member while the transparent resin layer of the laminate of the second aspect is positioned closer to the side of the support member than the conductive member.

The manufacturing method for a transparent antenna of the fifth aspect may include a curing step of curing the transparent resin layer (the resin composition of the transparent resin layer) in a state where the transparent resin layer and the conductive member are laminated on the support member to obtain a cured product (transparent base material), before the removing step C, after the removing step C, or before and after the removing step C. In the curing step, the transparent resin layer may be cured in a state where the transparent resin layer and the conductive member are laminated on the support member while the transparent resin layer is positioned closer to the side of the support member than the conductive member. The manufacturing method for a transparent antenna of the fifth aspect may include a processing step of patterning (for example, processing into a mesh shape) at least a part of the first conductive member after removing the second conductive member (after the removing step C). An example of the manufacturing method for a transparent antenna of the fifth aspect is a manufacturing method using the laminate having the aforementioned base material film, the aforementioned transparent resin layer (the transparent resin layer containing the uncured resin composition), and the aforementioned conductive member having the first conductive member and the second conductive member, as the laminate of the second aspect, the manufacturing method including the aforementioned removing step A (a first removing step), laminating step, curing step, and removing step C (a second removing step). In the manufacturing method for a transparent antenna of the fifth aspect, at least one selected from the group consisting of the first conductive member and the second conductive member may contain copper. Furthermore, the first conductive member of the laminate may be solid, and may have a pattern-shaped (for example, mesh-shaped) portion.

As a method for obtaining the transparent antenna of the first aspect, a sixth aspect of the manufacturing method for a transparent antenna of the present embodiment includes a removing step B of removing the protective film in a state where the transparent resin layer (the transparent resin layer containing at least one selected from the group consisting of the resin composition and the cured product thereof of the present embodiment), the conductive member, and the protective film are laminated on the support member in this order. In this case, the laminate may be, for example, an embodiment in which the conductive member is a single layer, and at least a part of the surface of the protective film on the side of the conductive member is subjected to a release treatment. The manufacturing method for a transparent antenna of the sixth aspect may include a removing step A of removing the base material film of the laminate of the second aspect and a laminating step of laminating the transparent resin layer, the conductive member, and the protective film on the support member, before the removing step B. The manufacturing method for a transparent antenna of the sixth aspect may include a curing step of curing the transparent resin layer (the resin composition of the transparent resin layer) to obtain a cured product (transparent base material), before the removing step B, after the removing step B, or before and after the removing step B.

The manufacturing method for a transparent antenna of the first to sixth aspects may include a covering member forming step of forming a covering member (a covering member not containing the resin composition and the cured product thereof of the present embodiment) on the conductive member, and may include a step of disposing a protective member (for example, a transparent member) on the covering member after the covering member forming step.

As a method for obtaining the transparent antenna of the second aspect, a seventh aspect of the manufacturing method for a transparent antenna of the present embodiment includes a covering member forming step of forming, on the conductive member, a covering member containing at least one selected from the group consisting of the resin composition and the cured product thereof of the present embodiment. In the covering member forming step, the covering member may be formed by supplying the resin composition of the present embodiment onto the conductive member, and the covering member (the transparent resin layer) may be formed by disposing the transparent resin layer of the laminate of the present embodiment on the conductive member. In the case of using the laminate of the present embodiment, the transparent resin layer of the laminate of the present embodiment may be disposed on the conductive member after removing the base material film or the protective film. The covering member forming step may be a step of forming a covering member containing at least one selected from the group consisting of the resin composition and the cured product thereof of the present embodiment on the conductive member of the laminate having the transparent resin layer (the transparent resin layer supporting the conductive member) and the conductive member disposed on the transparent resin layer, and may be a step of forming a covering member containing at least one selected from the group consisting of the resin composition and the cured product thereof of the present embodiment on the transparent resin layer and the conductive member of the laminate having the transparent resin layer (the transparent resin layer supporting the conductive member) and the conductive member disposed on a part of the transparent resin layer (for example, a part of the main surface of the transparent resin layer).

The manufacturing method for a transparent antenna of the seventh aspect may include a curing step of curing the covering member (the resin composition of the covering member) to obtain a cured product, before the covering member forming step, after the covering member forming step, or before and after the covering member forming step. The manufacturing method for a transparent antenna of the seventh aspect may include a curing step of curing the transparent resin layer (the resin composition of the transparent resin layer) supporting the conductive member to obtain a cured product (transparent base material), before the covering member forming step, after the covering member forming step, or before and after the covering member forming step. The covering member and the transparent resin layer supporting the conductive member may be cured in the same curing step. The manufacturing method for a transparent antenna of the seventh aspect may include a step of disposing a protective member (for example, a transparent member) on the covering member after the covering member forming step.

As a method for obtaining the transparent antenna of the second aspect, an eighth aspect of the manufacturing method for a transparent antenna of the present embodiment includes a laminating step of laminating, on the transparent resin layer, a laminate having a conductive member and a covering member disposed on the conductive member in a state where the conductive member of the laminate is positioned closer to the side of the transparent resin layer than the covering member, in which the covering member contains at least one selected from the group consisting of the resin composition and the cured product thereof of the present embodiment. As the laminate having a conductive member and a covering member disposed on the conductive member, the laminate of the second aspect can be used, and in the laminating step, the transparent resin layer of the laminate of the second aspect can be disposed as the covering member.

The manufacturing method for a transparent antenna of the eighth aspect may include a curing step of curing the covering member (the resin composition of the covering member) to obtain a cured product, before the laminating step, after the laminating step, or before and after the laminating step. The manufacturing method for a transparent antenna of the eighth aspect may include a curing step of curing the transparent resin layer (the resin composition of the transparent resin layer) to obtain a cured product (transparent base material), before the laminating step, after the laminating step, or before and after the laminating step. The covering member and the transparent resin layer may be cured in the same curing step. The manufacturing method for a transparent antenna of the eighth aspect may include a step of disposing a protective member (for example, a transparent member) on the covering member, before the laminating step, after the laminating step, or before and after the laminating step.

In the manufacturing methods for a transparent antenna of the seventh aspect and the eighth aspect, the transparent resin layer and the conductive member are the same as the transparent resin layer and the conductive member described above regarding the laminate and the transparent antenna of the present embodiment. The transparent resin layer may be supported by the support member. The covering member may have a portion disposed on the transparent resin layer without being disposed on the conductive member, in addition to a portion disposed on the conductive member, and may be in contact with the transparent base material and the conductive member.

In the aforementioned manufacturing methods for a transparent antenna of the first to eighth aspects, the steps, the configurations, and the like described above regarding each of the aspects may be combined with each other. For example, in the manufacturing method for a transparent antenna of the fifth aspect, the steps, the configurations, and the like described above regarding the manufacturing method for a transparent antenna of the fourth aspect can be used.

The transparent antenna of the present embodiment can be used in image display devices, constituent members (a front windshield, a rear windshield, a sunroof, a window, and the like) of automobiles, buildings, and the like. The image display device, the automobile, or the building of the present embodiment has the transparent antenna of the present embodiment. The image display device may have an image display unit displaying an image and a bezel portion (a frame portion) positioned around the image display unit, and the transparent antenna may be disposed in the image display unit. The image display device may be used in various electronic devices such as a personal computer, a navigation system (for example, a car navigation), a mobile phone, a watch, and an electronic dictionary.

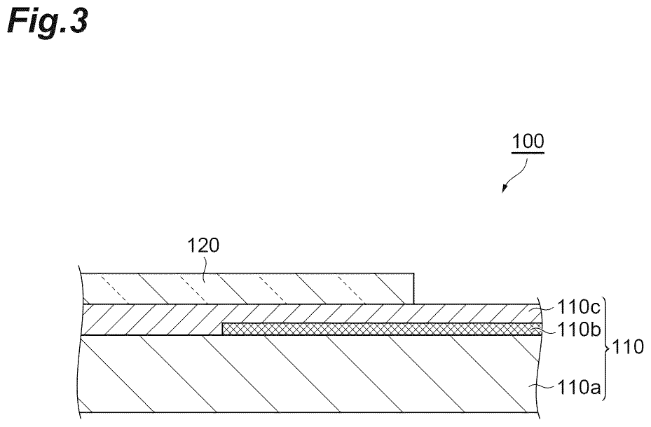

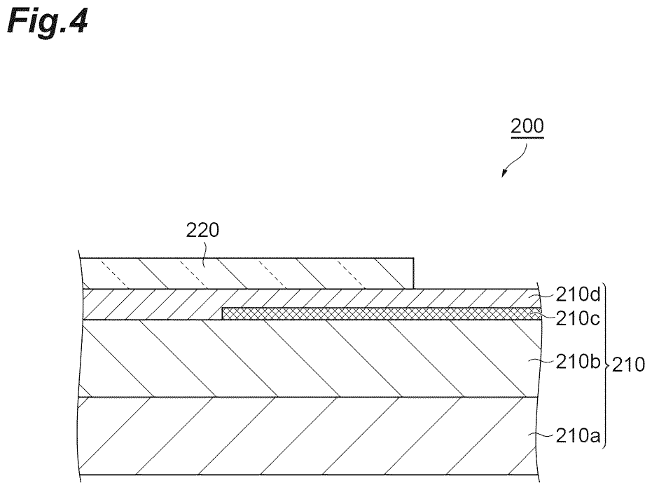

FIG. 3 and FIG. 4 are schematic sectional views illustrating an example of the image display device, and illustrate a part of the image display unit of the image display device. An image display device 100 of FIG. 3 has a transparent antenna 110 and a protective member 120 disposed on the transparent antenna 110. The transparent antenna 110 has a transparent base material 110a, a mesh-shaped conductive member 110b disposed on the transparent base material 110a, and a covering member 110c disposed on the transparent base material 110a and the conductive member 110b. An image display device 200 of FIG. 4 has a transparent antenna 210 and a protective member 220 disposed on the transparent antenna 210. The transparent antenna 210 has a transparent member 210a, a transparent base material 210b disposed on the transparent member 210a, a mesh-shaped conductive member 210c disposed on the transparent base material 210b, and a covering member 210d disposed on the transparent base material 210b and the conductive member 210c. The covering members 110c and 210d cover the transparent base materials 110a and 210b and the conductive members 110b and 210c.

In the image display device 100, at least one selected from the group consisting of the transparent base material 110a and the covering member 110c contains a cured product of the resin composition of the present embodiment, and for example, is composed of a cured product of the resin composition of the present embodiment. One of the transparent base material 110a and the covering member 110c may be formed of a material having a total light transmittance of 90% or more per 100 μm of the thickness (for example, a polyolefin such as a cycloolefin polymer). In the image display device 200, at least one selected from the group consisting of the transparent base material 210b and the covering member 210d contains a cured product of the resin composition of the present embodiment, and for example, is composed of a cured product of the resin composition of the present embodiment. One of the transparent base material 210b and the covering member 210d may be formed of a material having a total light transmittance of 90% or more per 100 μm of the thickness. The conductive members 110b and 210c are formed of, for example, copper. The transparent member 210a is formed of, for example, a polyolefin. The protective members 120 and 220 may be, for example, a glass plate.

### EXAMPLES

Hereinafter, the present disclosure will be further described by using Examples and Comparative Examples, but the present disclosure is not limited to the following Examples.

### <Preparation of Resin Varnish>

### Example 1

80 parts by mass of a styrene-based polymer 1 (maleic anhydride-modified styrene-butadiene-styrene block copolymer, manufactured by Asahi Kasei Corp., trade name: TUFPRENE 912, styrene content: 40% by mass), 20 parts by mass of an acrylic compound 1 (1,9-nonanediol diacrylate, manufactured by Showa Denko Materials Co., Ltd., trade name: FA-129AS), 1.0 part by mass of a polymerization initiator (2,5-dimethyl-2,5-bis(2-ethylhexanoylperoxy)hexane, manufactured by NOF CORPORATION, trade name: PERHEXA 25O), and 150 parts by mass of a solvent (toluene) were mixed under stirring to obtain a resin varnish.

### Example 2

A resin varnish was obtained in the same manner as in Example 1, except that a methacrylic compound 1 (1,9-nonanediol dimethacrylate, manufactured by SHIN-NAKAMURA CHEMICAL Co., Ltd., trade name: NK ESTER NOD-N) was used instead of the acrylic compound 1.

### Example 3

A resin varnish was obtained in the same manner as in Example 1, except that a methacrylic compound 2 (1,12-dodecanediol dimethacrylate, manufactured by SHIN-NAKAMURA CHEMICAL Co., Ltd., trade name: NK ESTER DDD) was used instead of the acrylic compound 1.

### Examples 4 to 6

Resin varnishes were obtained in the same manner as in Examples 1 to 3, except that a styrene-based polymer 2 (styrene-butadiene-styrene block copolymer, manufactured by Asahi Kasei Corp., trade name: ASAFLEX 810, MFR (ISO 1133, 200° C., 5 kgf): 5 g/10 min, vicat softening temperature (ISO 306, 10 N, 50° C./h): 83° C.) was used instead of the styrene-based polymer 1.

### Examples 7 to 9

Resin varnishes were obtained in the same manner as in Examples 1 to 3, except that a styrene-based polymer 3 (styrene-butadiene-styrene block copolymer, manufactured by Asahi Kasei Corp., trade name: ASAFLEX 830, MFR (ISO 1133, 200° C., 5 kgf): 6 g/10 min, vicat softening temperature (ISO 306, 10 N, 50° C./h): 72° C.) was used instead of the styrene-based polymer 1.

### Examples 10 to 12

Resin varnishes were obtained in the same manner as in Examples 1 to 3, except that a styrene-based polymer 4 (styrene-butadiene-styrene block copolymer, manufactured by Asahi Kasei Corp., trade name: ASAFLEX 840, MFR (ISO 1133, 200° C., 5 kgf): 7 g/10 min, vicat softening temperature (ISO 306, 10 N, 50° C./h): 81° C.) was used instead of the styrene-based polymer 1.

### Example 13

A resin varnish was obtained in the same manner as in Example 1, except that a styrene-based polymer 5 (styrene-ethylene-butylene-styrene block copolymer, manufactured by Asahi Kasei Corp., trade name: Tuftec H1041, styrene content: 32% by mass) was used as the styrene-based polymer 1.

### Comparative Example 1

A resin varnish was obtained in the same manner as in Example 1, except that a styrene-based polymer 6 (hydrogenated styrene-butadiene random copolymer, manufactured by JSR Corporation, trade name: DYNARON 2324P) was used instead of the styrene-based polymer 1, and the used amount of the polymerization initiator was changed to 0.2 parts by mass.

### <Evaluation of Tensile Elastic Modulus and Dielectric Properties of Cured Product>

A surface-release-treated PET film (manufactured by FUJIMORI KOGYO CO., LTD., trade name: HTA, thickness: 75 μm) was prepared as a base material film. The aforementioned resin varnish was applied onto the release-treated surface of this PET film by using a knife coater (manufactured by Yasui Seiki Company, Ltd., trade name: SNC-300). Next, drying was performed at 100° C. for 10 minutes in a dryer (manufactured by FUTABA Co., Ltd., trade name: MSO-80TPS) to form a resin film. The thickness of the resin film after drying was adjusted to 100 μm by adjusting the gap of the coater. A surface-release-treated PET film (manufactured by FUJIMORI KOGYO CO., LTD., trade name: BD, thickness: 75 μm) was prepared as a protective film, and then the release-treated surface of the protective film was attached to the resin film, thereby obtaining a laminated film A.

The aforementioned laminated film A was subjected to a thermal treatment at 120° C. for 30 minutes in a dryer (manufactured by FUTABA Co., Ltd., trade name: MSO-80TPS) to thermally cure the resin film, thereby obtaining a film for evaluation having the base material film, the cured film, and the protective film.

A laminate with a length of 50 mm and a width of 10 mm was cut out from the aforementioned film for evaluation, and then, the base material film and the protective film of this laminate were removed to obtain a test piece. A stress-strain curve of the test piece was measured using an autograph (manufactured by SHIMADZU CORPORATION, trade name: EZ-S) in the environment of 25° C. to determine a tensile elastic modulus from the stress-strain curve. A distance between chucks in the measurement was set to 20 mm, and a tension rate was set to 50 mm/min. As the tensile elastic modulus, a value at a load of 0.5 N to 1.0 N was measured. Results are shown in Table 1.

A laminate with a length of 80 mm and a width of 80 mm was cut from the aforementioned film for evaluation of each of Examples 1 to 12 as a test piece, and then the dielectric constant (Dk) and the dielectric dissipation factor (Df) of this entire test piece were measured with a split post dielectric resonator method (SPDR method) by using a vector type network analyzer (manufactured by Agilent Technologies, Inc., trade name: E8364B) and a 10 GHz resonator (manufactured by Kanto Electronics Application Development Co., Ltd., trade name: CP531) in the environment of 25° C. Furthermore, a laminate (length: 80 mm, width: 80 mm) in which only the aforementioned base material film and the aforementioned protective film were laminated was produced, and then the dielectric constant and the dielectric dissipation factor of this laminate were measured with the same method. By subtracting the measurement results of the aforementioned laminate (the laminate in which only the base material film and the protective film were laminated) from the measurement results of the aforementioned test piece, the dielectric constant and the dielectric dissipation factor of the cured film were obtained. Results are shown in Table 1.

### <Measurement of Total Light Transmittance>

A laminate with a length of 30 mm and a width of 30 mm was cut out from the aforementioned film for evaluation of each of Examples 1, 10, and 13, and then, the base material film and the protective film of this laminate were removed to obtain a test piece. The total light transmittance (T.T.) of the test piece was measured by the method according to JIS K 7136. Specifically, the test piece was irradiated with a white LED lamp in the environment of 25° C., and the total light transmittance of the light passing through the test piece was measured. As the measurement apparatus, SH7000 (trade name) manufactured by NIPPON DENSHOKU INDUSTRIES CO., LTD. was used. The total light transmittance was 91% in Example 1, 90% in Example 10, and 92% in Example 13. By the same measurement, also in Examples other than Examples 1, 10, and 13, the total light transmittance of 90% or more is obtained.

### <Evaluation of Wrinkle Appearance>

As a copper member, a laminate (manufactured by MITSUI MINING & SMELTING CO., LTD., trade name: MT-18FL) of a copper foil A (thickness: 18 μm) and a copper foil B (thickness: 2 μm) was prepared. The protective film of the aforementioned laminated film A was removed, and then the exposed resin film (the resin film of the laminated film A) and the copper foil B of the aforementioned copper member were bonded using a compression vacuum laminator (manufactured by Nikko-Materials Co., Ltd., trade name: V130) under the conditions of a pressure of 0.5 MPa, vacuuming for 10 seconds, and press-bonding for 30 seconds. The base material film (the base material film of the laminated film A) was removed, and then the exposed resin film and a COP film (thickness: 100 μm) were bonded using a compression vacuum laminator (manufactured by Nikko-Materials Co., Ltd., trade name: V130) under the conditions of a pressure of 0.5 MPa, vacuuming for 10 seconds, and press-bonding for 30 seconds, thereby obtaining a laminated film B.

The aforementioned laminated film B was subjected to a thermal treatment at 120° C. for 30 minutes in a dryer (manufactured by FUTABA Co., Ltd., trade name: MSO-80TPS) to thermally cure the resin film, thereby obtaining a film for evaluation having the COP film, the cured film, the copper foil B, and the copper foil A.

A laminate with a length of 100 mm and a width of 100 mm was cut out from the aforementioned film for evaluation to obtain a test piece. The copper foil A was removed from this test piece, and presence or absence of wrinkles on the exposed copper foil B was checked. A case where there were no wrinkles was evaluated as “A”, and a case where there were wrinkles was evaluated as “B”. Results are shown in Table 1.

TABLE 1

| | | Example | | | | | | |
|---|---|---|---|---|---|---|---|---|
| | | 1 | 2 | 3 | 4 | 5 | 6 | 7 |
| Composition | Styrene-based polymer 1 | 80 | 80 | 80 | | | | |
| | Styrene-based polymer 2 | | | | 80 | 80 | 80 | |
| | Styrene-based polymer 3 | | | | | | | 80 |
| | Styrene-based polymer 4 | | | | | | | |
| | Styrene-based polymer 5 | | | | | | | |
| | Styrene-based polymer 6 | | | | | | | |
| | Acrylic compound 1 | 20 | | | 20 | | | 20 |
| | Methacrylic compound 1 | | 20 | | | 20 | | |
| | Methacrylic compound 2 | | | 20 | | | 20 | |
| | Polymerization initiator | 1.0 | 1.0 | 1.0 | 1.0 | 1.0 | 1.0 | 1.0 |
| Tensile elastic modulus [MPa] | | 206 | 184 | 137 | 374 | 445 | 401 | 232 |
| Dielectric | Dielectric constant | 2.4 | 2.5 | 2.4 | 2.5 | 2.5 | 2.5 | 2.5 |
| properties | Dielectric dissipation factor | 0.0060 | 0.0035 | 0.0036 | 0.0052 | 0.0028 | 0.0033 | 0.0046 |

| | | | | | | | |
|---|---|---|---|---|---|---|---|
| Wrinkle appearance | A | A | A | A | A | A | A |

| | | | | | | | | Comparative |
|---|---|---|---|---|---|---|---|---|
| | | Example | | | | | | Example |
| | | 8 | 9 | 10 | 11 | 12 | 13 | 1 |
| Composition | Styrene-based polymer 1 | | | | | | | |
| | Styrene-based polymer 2 | | | | | | | |
| | Styrene-based polymer 3 | 80 | 80 | | | | | |
| | Styrene-based polymer 4 | | | 80 | 80 | 80 | | |
| | Styrene-based polymer 5 | | | | | | 80 | |
| | Styrene-based polymer 6 | | | | | | | 80 |
| | Acrylic compound 1 | | | 20 | | | 20 | 20 |
| | Methacrylic compound 1 | 20 | | | 20 | | | |
| | Methacrylic compound 2 | | 20 | | | 20 | | |
| | Polymerization initiator | 1.0 | 1.0 | 1.0 | 1.0 | 1.0 | 1.0 | 0.2 |
| Tensile elastic modulus [MPa] | | 348 | 417 | 380 | 419 | 505 | 4.1 | 0.8 |
| Dielectric | Dielectric constant | 2.5 | 2.5 | 2.5 | 2.4 | 2.5 | | |
| properties | Dielectric dissipation factor | 0.0024 | 0.0031 | 0.0047 | 0.0021 | 0.0030 | | |

| | | | | | | | |
|---|---|---|---|---|---|---|---|
| Wrinkle appearance | A | A | A | A | A | B | B |

### REFERENCE SIGNS LIST

10, 20, 30: laminate, 10a, 20a, 30a: base material film, 10b, 20b, 30b: transparent resin layer, 10c: protective film, 20c, 30c, 30d, 110b, 210c: conductive member, 100, 200: image display device, 110, 210: transparent antenna, 110a, 210b: transparent base material, 110c, 210d: covering member, 120, 220: protective member, 210a: transparent member.

1. A resin composition comprising: a styrene-based block copolymer; a (meth)acrylic compound; and a polymerization initiator.

2. The resin composition according to claim 1, wherein the styrene-based block copolymer includes a styrene-butadiene-styrene block copolymer.

3. The resin composition according to claim 1, wherein a content of the styrene-based block copolymer is 50% by mass or more based on a total mass of the resin composition.

4. The resin composition according to claim 1, wherein the (meth)acrylic compound includes a methacrylic compound.

5. The resin composition according to claim 1, wherein the (meth)acrylic compound includes alkanediol di(meth)acrylate.

6. The resin composition according to claim 1, wherein the (meth)acrylic compound includes alkanediol dimethacrylate.

7. The resin composition according to claim 1, wherein the (meth)acrylic compound includes a compound represented by General Formula (I) below: 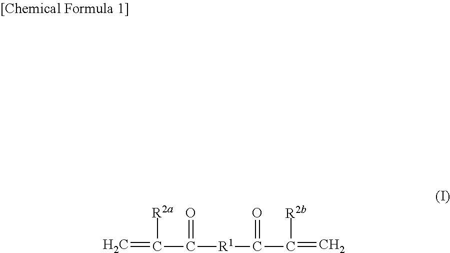
[in the formula, R¹ represents a group having 9 or less carbon atoms and 2 or more oxygen atoms, and R^{2a} and R^{2b} each independently represent a hydrogen atom or a methyl group].

8. The resin composition according to claim 7, wherein the (meth)acrylic compound includes a compound in which at least one of R^{2a} and R^{2b} is a methyl group in General Formula (I) above.

9. The resin composition according to claim 1, wherein a content of the (meth)acrylic compound is 1 to 300 parts by mass with respect to 100 parts by mass of the styrene-based block copolymer.

10. The resin composition according to claim 1, wherein the polymerization initiator includes a peroxide.

11. The resin composition according to claim 1, wherein the polymerization initiator includes a peroxyester.

12. A cured product of the resin composition according to claim 1.

13. A laminate comprising: a base material film; and a transparent resin layer disposed on the base material film, wherein
the transparent resin layer contains at least one selected from the group consisting of the resin composition according to claim 1 and a cured product thereof.

14. The laminate according to claim 13, further comprising a conductive member disposed on the transparent resin layer.

15. The laminate according to claim 14, wherein the conductive member contains copper.

16. The laminate according to claim 14, wherein a thickness of the conductive member is 5 μm or less.

17. A transparent antenna comprising: a transparent base material; a conductive member disposed on the transparent base material; and a covering member disposed on the conductive member, wherein
at least one selected from the group consisting of the transparent base material and the covering member contains a cured product of the resin composition according to claim 1.

18. The transparent antenna according to claim 17, wherein the conductive member has a mesh-shaped portion.

19. The transparent antenna according to claim 17, wherein the conductive member contains copper.

20. An image display device comprising the transparent antenna according to claim 17.
